(19) United States
(12) Patent Application Publication
(10) Pub. No.: US 2011/0037751 A1
(43) Pub. Date: Feb. 17, 2011

(54) PLASMA DISPLAY DEVICE AND DRIVING METHOD THEREOF

(75) Inventors: Yoojin Song, Suwon-si (KR); Kyongpil Jin, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/855,580

(22) Filed: Aug. 12, 2010

(30) Foreign Application Priority Data
Aug. 17, 2009 (KR) 10-2009-0075728

(51) Int. Cl. G09G 3/28; G06F 3/038

(52) U.S. Cl. 345/211; 345/60

(57) ABSTRACT

A plasma display device is disclosed. The plasma display device includes a driver circuit configured to apply signals to the array of the display, where the driver circuit receives a power signal which is about half the voltage of the signals.

### CROSS-REFERENCE TO RELATED APPLICATIONS

This application claims priority to and the benefit of Korean Patent Application No. 10-2009-0075728 filed on Aug. 17, 2009, the entire content of which is incorporated herein by reference.

### BACKGROUND

1. Field

The field is related to a plasma display device in which a sustain voltage is applied to an electrode using a charge circuit and a power voltage that is half the voltage of the sustain voltage. Accordingly, withstanding voltages of a switching device and a capacitor of the driving circuit are reduced. Therefore, manufacturing costs, power losses and thickness of the device are reduced.

2. Description of the Related Technology

Plasma display devices include a plasma display panel that displays characters or images using plasma generated by a gas discharge. In the plasma display panel, discharge cells are arranged in a matrix format.

The plasma display panel divides a frame into a plurality of subfields, each having a different weight value, and drives the plurality of subfields to display an image. Each of the subfields includes a reset period, an address period, and a sustain period. The reset period is a period in which discharge cells are initialized to stably perform an address discharge. The address period is a period in which the address discharge for selecting cells to be turned on and turned off in the plasma display panel is performed. The sustain period is a period in which a sustain discharge for displaying an actual image on the cells to be turned on is performed.

In typical plasma display devices, a high-voltage sustain voltage Vs (about 190 V to about 210 V) is applied to a scan electrode and a sustain electrode, which perform a sustain discharge during a sustain period. To apply the high-voltage sustain voltage Vs, since a switching device and various capacitors used for a driving circuit of the plasma display device should have an high withstanding voltage, manufacturing costs increase due to the manufacture of the switches having the high withstanding voltage.

Also, the sustain voltage Vs further increases as a result of an increase of content and pressure of the discharge gas used for the plasma display device.

Due to the increase of the sustain voltage Vs, the withstanding voltages and the sizes of the switching device and the various capacitors used for the driving circuit of the plasma display device are increased. Accordingly, the manufacturing costs and power losses also increase. Thus, it is difficult to realize the desired slimness of the plasma display device.

In addition, due to the increase of the sustain voltage Vs, since a power source including a switching mode power supply supplying the sustain voltage Vs is required to have the high voltage, it is difficult to design the power source having the high voltage, and also, manufacturing costs thereof also increase.

### SUMMARY OF CERTAIN INVENTIVE ASPECTS

One aspect is a plasma display device. The plasma display device includes a plasma display panel including a plurality of first electrodes, and a first driver connected to the first electrodes. The first driver includes a sustain pulse generating circuit, where the sustain pulse generating circuit includes first and second power receiving terminals configured to receive a power voltage that is about half the voltage of a first voltage applied to the plurality of first electrodes, a first switch including a first terminal connected to the first power receiving terminal, an inductor including a first terminal connected to the first electrodes, a second switch including a first terminal connected to a second terminal of the inductor and a second terminal connected to a second terminal of the first switch, a third switch connected to the first electrodes, a charge circuit connected to the first and second power receiving terminals, to the first terminal of the first switch, and to a first terminal of the third switch, and a fourth switch including a first terminal connected to a second terminal of the third switch and the first terminal of the inductor, and a second terminal connected to a ground.

Another aspect is a method of driving a plasma display device. The device includes a plurality of first electrodes and a power voltage source supplying a power voltage that is about half the voltage of a first voltage applied to the electrodes. The driving method includes increasing a voltage of the first electrodes from the power voltage to the first voltage while charging a charge circuit with a charge voltage, applying to the first electrodes a voltage that is the sum of the power voltage and the charge voltage, recovering power from the first electrodes to the power voltage source and to the charge circuit to drop the voltage of the first electrodes from the first voltage to a second voltage lower than the first voltage, and connecting the first electrodes to a ground.

Another aspect is a plasma display device including a plasma display panel including a plurality of first electrodes, and a first driver configured to apply a sustain pulse to the first electrodes. The first driver includes a charge circuit having first and second charge terminals, first and second power receiving terminals for receiving power from a power voltage source, a first path including an inductor disposed between the first power receiving terminal and the first electrodes, a second path for applying a voltage of the power voltage source to the first and second terminals of the charge circuit, a third path for connecting the first power receiving terminal to the first electrodes via the charge circuit, and a fourth path for connecting the first electrodes to the second power receiving terminal.

### BRIEF DESCRIPTION OF THE DRAWINGS

FIG. 1 illustrates a schematic block diagram of the plasma display device according to an embodiment;

FIG. 2 illustrates a driving waveform diagram of a plasma display device according to an embodiment;

FIG. 3 illustrates a sustain pulse generating circuit of a sustain driver for generating a sustain pulse of FIG. 2;

FIG. 4 illustrates an operation timing diagram of the sustain pulse generating circuit of FIG. 3; and

FIGS. 5A to 8B illustrate views of current paths and a process for generating a sustain pulse according to an operation of the sustain pulse generating circuit of FIG. 3.

### DETAILED DESCRIPTION OF CERTAIN INVENTIVE EMBODIMENTS

Certain embodiments will now be described with reference to the accompanying drawings; however, they may be embodied in different forms and should not be construed as limited to the embodiments set forth herein.

When a certain element is “connected” to another element, it means that they are either “directly connected” to each other or “indirectly connected” to each other with another device being interposed therebetween.

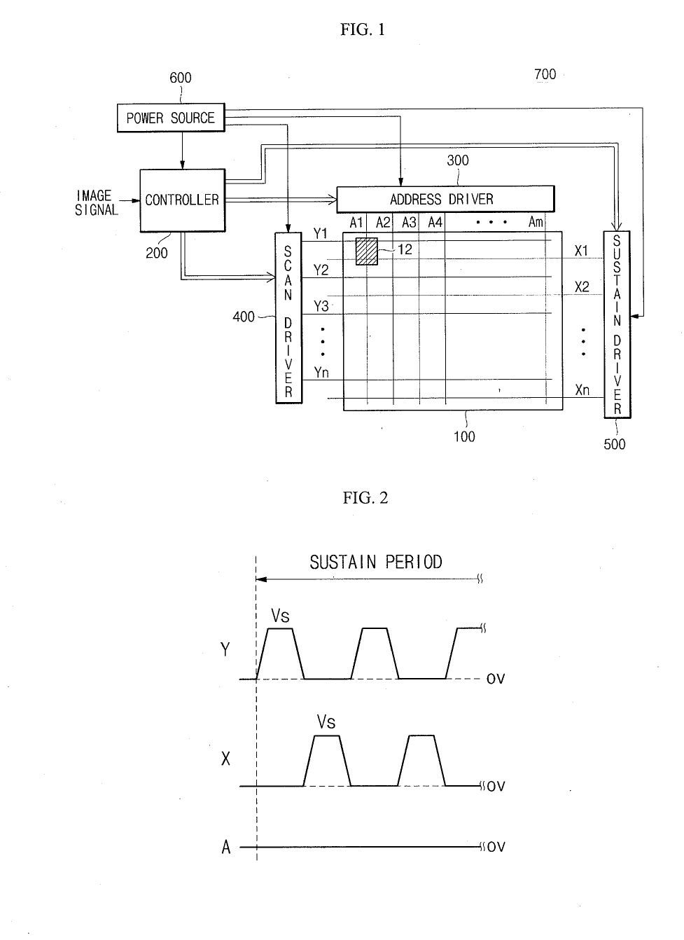

FIG. 1 illustrates a schematic block diagram of the plasma display device according to an embodiment.

Referring to FIG. 1, a plasma display device 700 includes a plasma display panel (PDP) 100, a controller 200, an address driver 300, a scan driver 400, a sustain driver 500, and a power source 600.

The PDP 100 includes a plurality of address electrodes (hereinafter, referred to as “A electrodes”) A1 through Am arranged in a column direction, a plurality of sustain electrodes (Hereinafter, referred to as “X electrodes”) X1 through Xn arranged in a row direction, and a plurality of scan electrodes (hereinafter, referred to as “Y electrodes”) Yl through Yn arranged in the row direction. The X electrodes and the Y electrodes are disposed in pairs. The X electrodes X1 through Xn are formed corresponding to the respective Y electrodes Y1 through Yn, and the X electrodes and the Y electrodes perform an operation of a sustain discharge for displaying images during sustain periods. The Y electrodes Y1 through Yn and the X electrodes X1 through Xn are perpendicular to the A electrodes A1 through Am. Discharge spaces near crossing points of the A electrodes A1 through Am, the X electrode X1 through Xn, and the Y electrodes Y1 through Yn form cells 12. Such a PDP 100 is an example, and a panel having a different structure in which a driving waveform to be described later is applicable may be used as the plasma display panel 100.

The controller 200 receives image signals to generate and output address control signals, sustain control signals, and scan control signals. The controller 200 divides each frame into a plurality of subfields and outputs the signals during the subfields. Each subfield includes a reset period, an address period, and a sustain period.

The address driver 300 responds to the address control signals received from the controller 200 by supplying display data signals to the respective A electrodes A1 through Am for selecting desired discharge cells for display.

The scan driver 400 responds to the scan control signals received from the controller 200 by applying driving voltages to the Y electrodes Y1 through Yn.

The sustain driver 500 responds to the sustain control signals received from the controller 200 by applying driving voltages to the X electrodes X1 through Xn.

The power source 600 supplies power required for driving the plasma display device 700 to the respective drivers 300, 400, and 500. Although a switching mode power supply (not shown) that is small in size, light in weight, and high in efficiency is used as the power source 600 to supply the driving voltage to the controller 200 and the respective drivers 300, 400, and 500, the power source 600 is not limited thereto.

FIG. 2 illustrates a driving waveform diagram of a plasma display device according to an embodiment. A driving waveform applied during the sustain period in driving waveforms of the plasma display device is illustrated.

In the plasma display panel 100, the reset period, the address period, and the sustain period are sequentially performed in each subfield to display an image.

Referring to FIG. 2, during the sustain period, a sustain pulse alternately having a Vs voltage (or referred to as a first voltage) and a ground voltage (0 V: or referred to as a second voltage) is applied in opposite phases to the X electrode (also referred to as a first electrode) and the Y electrode (also referred to as a second electrode) to cause sustain discharge between the X electrode and the Y electrode. The ground voltage 0V is applied to the A electrode. Thereafter, a process in which the sustain pulse of the Vs voltage is applied to the Y electrode and a process in which the sustain pulse of the Vs voltage is applied to the X electrode are performed repeatedly for a number of times corresponding to a weight value of the corresponding subfield. In some embodiments, the Vs voltage ranges from about 190 V to about 210 V.

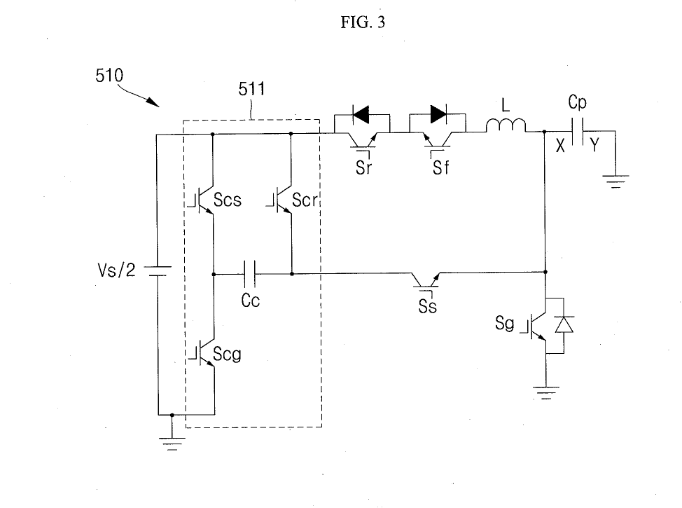

A sustain pulse generating circuit for generating the sustain pulse of FIG. 2 will be described with reference to FIG. 3.

FIG. 3 illustrates a sustain pulse generating circuit of a sustain driver for generating a sustain pulse of FIG. 2.

In some embodiments, the sustain pulse generating circuit 510 is disposed in only the sustain driver 500 (also referred to as a first driver) connected to the plurality of X electrodes X1 through Xn, but is not limited thereto. For example, the sustain pulse generating circuit 510 may be disposed in the scan driver 400 connected to the plurality of Y electrodes Y1 through Yn.

In FIG. 3, a capacitive element formed by the Y electrode adjacent to the X electrode is illustrated as a panel capacitor Cp, and the Y electrode of the panel capacitor Cp is biased to the ground voltage. Also, a switching element to be described later is illustrated as an n-channel insulated gate bipolar transistor (n-channel IGBT). However, other switching elements performing the same or similar function as the n-channel IGBT may be used as the switching element.

Referring again to FIG. 3, the sustain pulse generating circuit 510 includes a power voltage source Vs/2, a first switch Sr, an inductor L, a second switch Sf, a third switch Ss, a charge circuit 511, and a fourth switch Sg. The sustain pulse generating circuit 510 applies the sustain pulse alternately having the Vs voltage and the ground voltage 0V to the X electrode during the sustain period.

The power voltage source Vs/2 is connected to a capacitor connected to an output terminal of the switching mode power supply (not shown) of the power source 600 to supply a power voltage Vs/2 that, is about half the voltage of the Vs voltage applied to the X electrode for a sustain driving of the panel capacitor Cp. Here, a first terminal of the power voltage source Vs/2 may include a plus terminal, and a second terminal of the power voltage source Vs/2 may include a minus terminal.

The first switch Sr is electrically connected between the first terminal of the power voltage source Vs/2 and the X electrode. The inductor L is connected to between the first switch Sr and the X electrode. The second switch Sf is electrically connected to between the first switch Sr and the inductor L. The first switch Sr, the inductor L, and the second switch Sf control current flow between the first terminal of the power voltage source Vs/2 and the X electrode to generate resonance.

The first switch Sr may include a first terminal connected to the first terminal of the power source Vs/2, a second terminal connected to a second switch Sf, a third terminal for controlling an operation of the first switch Sr, and a body diode connected between the first terminal and the second terminal and including an anode connected to the second terminal of the first switch Sr and a cathode connected to the first terminal of the first switch Sr. When the first switch Sr turns on, current flows from the first terminal to the second terminal. The first terminal of the first switch Sr may include a collector terminal, the second terminal may include an emitter terminal, and the third terminal may include a gate terminal.

The inductor L may include a first terminal connected to the X electrode and a second terminal connected to the second switch Sf. The inductor L forms an LC resonant circuit together with the panel capacitor Cp. Due to the LC resonant circuit, the power supplied from the power voltage source Vs/2 may be applied to the X electrode with voltage Vs.

The second switch Sf may include a first terminal connected to the second terminal of the inductor L, a second terminal connected to the second terminal of the first switch Sr, a third terminal for controlling an operation of the second switch Sf, and a body diode connected between the first terminal and the second terminal of the second switch Sf and including an anode connected to the second terminal of the second switch Sf and a cathode connected to the first terminal of the second switch Sf. When the second switch Sf turns on, current flows from the first terminal to the second terminal. The first terminal of the second switch Sf may include a collector terminal, the second terminal may include an emitter terminal, and the third terminal may include a gate terminal.

The third switch Ss may include a first terminal connected to the second terminal of the charge circuit 511, a second terminal connected between the first terminal of the inductor L and the X electrode, and a third terminal for controlling an operation of the third switch Ss. When the third switch Ss turns on, current flows from the first terminal to the second terminal. Here, the first terminal of the third switch Ss may include a collector terminal, the second terminal may include an emitter terminal, and the third terminal may include a gate terminal.

The charge circuit 511 is connected to the first and second terminals of the power voltage source Vs/2, the first terminal of the first switch Sr, and the first terminal of the third switch Ss. The charge circuit 511 may be charged with the power voltage Vs/2 supplied from the power voltage source Vs/2 or a half voltage of a voltage recovered from the X electrode.

The charge circuit 511 may include a first charge switch Scg, a charge capacitor Cc, a second charge switch Scs, and a third charge switch Scr.

The first charge switch Scg is connected between the second terminal of the power voltage source Vs/2 and the first terminal of the third switch Ss. Specifically, the first charge switch Scg may include a first terminal connected to a first terminal of the charge capacitor Cc to be described later, a second terminal connected to the second terminal of the power voltage source Vs/2, and a third terminal for controlling an operation of the first charge switch Scg. When the first charge switch Scg turns on, current flows form the first terminal to the second terminal. The first terminal of the first charge switch Scg may include a collector terminal, the second terminal may include an emitter terminal, and the third terminal may include a gate terminal.

The charge capacitor Cc is connected between the first charge switch Scg and the third switch Ss. Specifically, the charge capacitor Cc may include a first terminal connected to the first terminal of the first charge switch Scg and a second terminal connected to the first terminal of the third switch Ss.

The second charge switch Scs is connected between the first terminal of the power voltage source Vs/2 and the first terminal of the charge capacitor Cc. Specifically, the second charge switch Scs may include a first terminal connected between the first terminal of the power voltage source Vs/2 and the first terminal of the first switch Sr, a second terminal connected between the first terminal of the first charge switch Scg and the first terminal of the charge capacitor Cc, and a third terminal for controlling an operation of the second charge switch Scs. When the second charge switch Scs turns on, current flows from the first terminal to the second terminal. Here, the first terminal of the second charge switch Scs may include a collector terminal, the second terminal may include an emitter terminal, and the third terminal may include a gate terminal.

The third charge switch Scr is connected between the first terminal of the power voltage source Vs/2 and the second terminal of the charge capacitor Cc. Specifically, the third charge switch Scr may include a first terminal connected between the first terminal of the second charge switch Scs and the first terminal of the first switch Sr, a second terminal connected between the second terminal of the charge capacitor Cc and the first terminal of the third switch Ss, and a third terminal for controlling an operation of the third charge switch Scr. When the third charge switch Scr turns on, current flows from the first terminal to the second terminal. Here, the first terminal of the third charge switch Scr may include a collector terminal, the second terminal may include an emitter terminal, and the third terminal may include a gate terminal.

In the charge circuit 511 including the above-described components, the first charge switch Scg and the third charge switch Scr may be turned on to charge the charge capacitor Cc with the power voltage Vs/2 of the power voltage source Vs/2. As a result, the Vs voltage that is the sum of the power voltage Vs/2 charged into the charge capacitor Cc of the charge circuit 511 and the power voltage Vs/2 of the power voltage source Vs/2 may be applied to the X electrode. Thus, the Vs voltage is applied to the X electrode, and also, the power source 600 and the sustain generating circuit 510 are operated at a Vs/2 voltage lower than the Vs voltage to reduce voltage loss.

The fourth switch Sg is connected to a ground at a position between the third switch Ss and the X electrode to control current flow so that the ground voltage 0V is applied to the X electrode. Specifically, the fourth switch Sg may include a first terminal connected between the second terminal of the third switch Ss and the first terminal of the inductor L, a second terminal connected to the ground, and a third terminal for controlling an operation of the fourth switch Sg. When the fourth switch Sg turns on, current flows from the first terminal to the second terminal. Here, the first terminal of the fourth switch Sg may include a collector terminal, the second terminal may include an emitter terminal, and the third terminal may include a gate terminal.

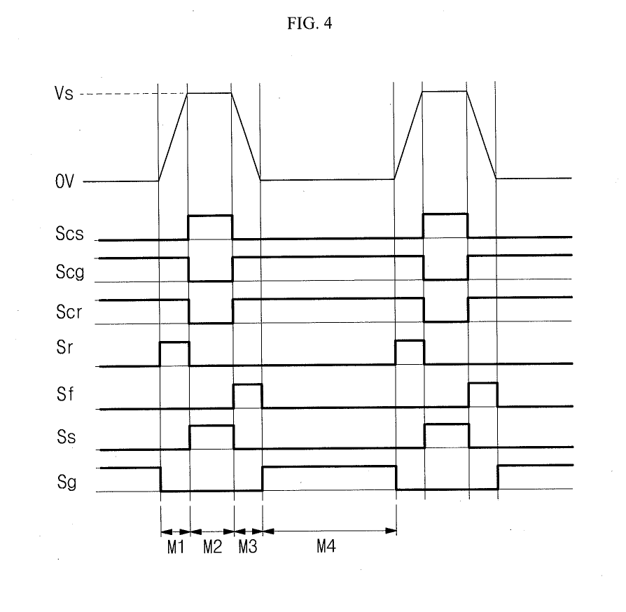

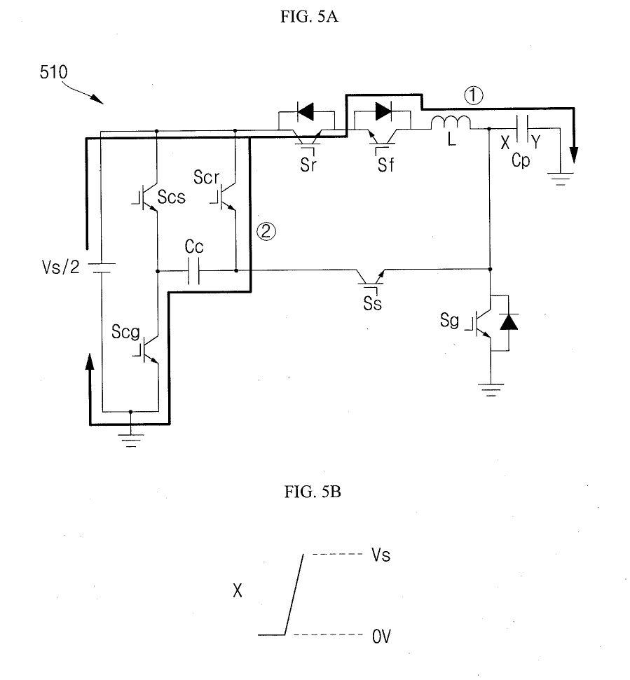

Operation for each mode of the sustain generating circuit 510 applying the sustain pulse to the X electrode during the sustain period will be described with reference to FIGS. 4 to 8B.

FIG. 4 illustrates an operation timing diagram of the sustain pulse generating circuit of FIG. 3, and FIGS. 5A to 8B illustrate views of current paths and a process for generating a sustain pulse according to an operation of the sustain pulse generating circuit of FIG. 3.

It is assumed that the X electrode of the panel capacitor Cp is connected to the ground voltage 0V.

In a driving method of the plasma display device 700 according to an embodiment, a method of applying the sustain pulse alternately having the Vs voltage and the ground voltage 0V during the sustain period to the X electrode includes increasing a voltage of the X electrode to the Vs voltage to charge the power voltage Vs/2 of the power voltage source Vs/2 in the charge circuit 511, maintaining the voltage of the X electrode with the Vs voltage, decreasing the voltage of the X electrode to the ground voltage 0V to charge the Vs/2 voltage in the charge circuit 511, and maintaining the voltage of the X electrode with the ground voltage 0V.

In mode 1 M1, shown in FIG. 5A, the first switch Sr is turned on to generate an LC resonance in a current path formed from the first terminal of the power voltage source Vs/2 to the X electrode of the panel capacitor Cp through the first switch Sr, the body diode of the second switch Sf and the inductor L, as shown in FIG. 5A (\textcircled{1}). Due to the LC resonance, the Vs voltage that is equal to two times the power voltage Vs/2 of the power voltage source Vs/2 is applied to the X electrode. Thus, as shown in FIG. 5B, the voltage of the X electrode increases from the ground voltage 0V to the Vs voltage. The first charge switch Scg and the third charge switch Scr of the charge circuit 511 are turned on to form a current path from the first terminal of the power voltage source Vs/2 to the second terminal of the power voltage source Vs/2 through the third charge switch Scr, the charge capacitor Cc, and the first charge switch Scg (\textcircled{2}). As a result, the power voltage Vs/2 of the power voltage source Vs/2 is charged in the charge capacitor Cc of the charge circuit 511.

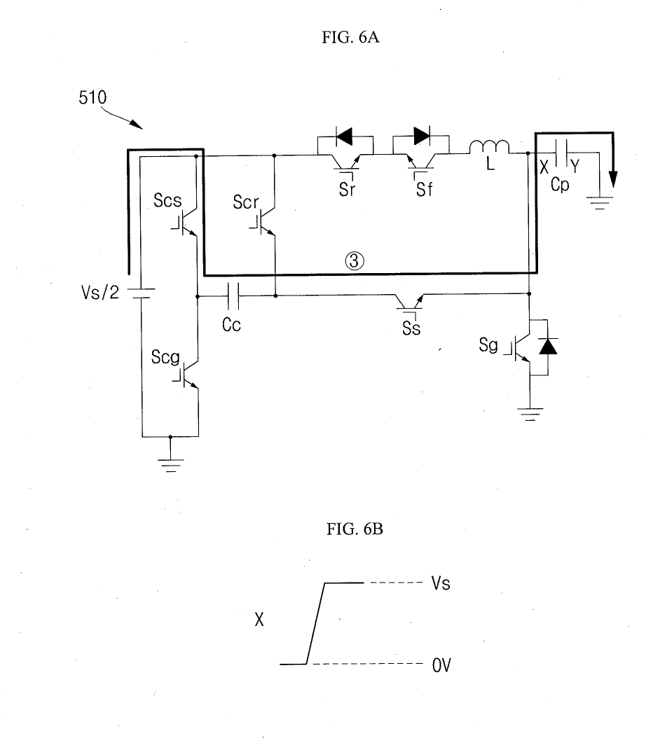

In mode 2 M2, shown in FIG. 6A, the first switch Sr, the first charge switch Scg, and the third charge switch Scr are turned off, and the second charge switch Scs and the third switch Ss are turned on to form a current path from the first terminal of the power voltage source Vs/2 to the X electrode of the panel capacitor Cp through the second charge switch Scs of the charge circuit 511, the charge capacitor Cc, and the third switch Ss, as shown in FIG. 6A (\textcircled{3}). The Vs voltage that is the sum of the power voltage Vs/2 of the power voltage source Vs/2 and the power voltage Vs/2 into the charge capacitor Cc is applied to the X electrode by the current path. Thus, as shown in FIG. 6B, the voltage of the X electrode is maintained with the Vs voltage.

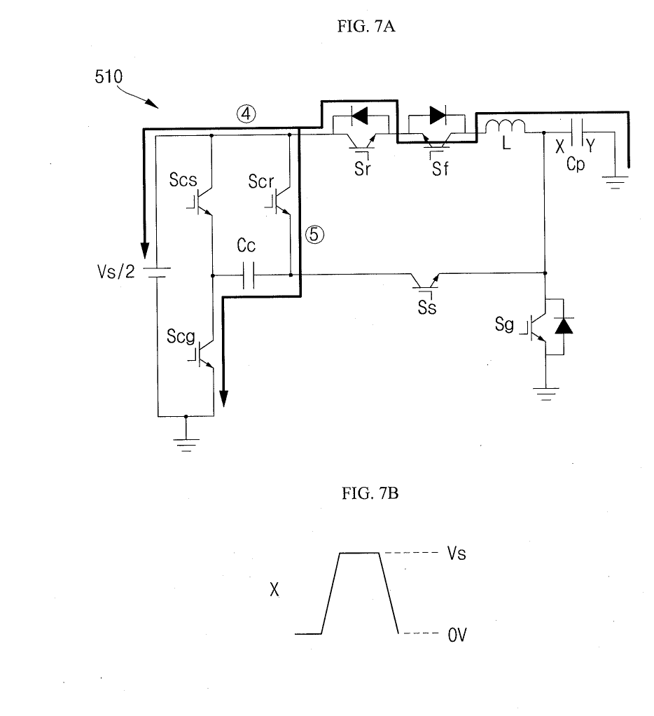

In mode 3 M3, shown in FIG. 7A the second charge switch Scs and the third switch Ss are turned off, and the second switch Sf is turned on to generate an LC resonance in a current path formed from the X electrode of the panel capacitor Cp to the first terminal of the power voltage source Vs/2 through the inductor L, the second switch Sf and the body diode of the first switch Sr, as shown in FIG. 7A (\textcircled{4}). The Vs voltage of the X electrode is recovered to the first terminal of the power voltage source Vs/2 by the LC resonance. Thus, as shown in FIG. 7B, the voltage of the X electrode is dropped to the ground voltage 0V. In addition, the first charge switch Scg and the third charge switch Scr are turned on to form a current path from the X electrode of the panel capacitor Cp to the second terminal of the power voltage source Vs/2 through the second switch Sf and the body diode of the first switch Sr, the third charge switch Scr, the charge capacitor Cc, and the first charge switch Scg (\textcircled{5}). As a result, the charge capacitor Cc is charged with a half voltage of the Vs voltage. Thus, since the charge capacitor Cc is charged with the Vs/2 voltage when the voltage of the X electrode rises from the ground voltage 0V to the Vs voltage, as well as when the voltage of the X electrode is dropped from the Vs voltage to the ground voltage 0V, the charge capacitor Cc is stably charged with the Vs/2 voltage in the plasma display device 700 in which a sudden current flow is created. Thus, when the next sustain pulse is generated, the Vs voltage that is the sum of the Vs/2 charged into the charge capacitor Cc and the power voltage Vs/2 of the power voltage source Vs/2 may be applied to the X electrode.

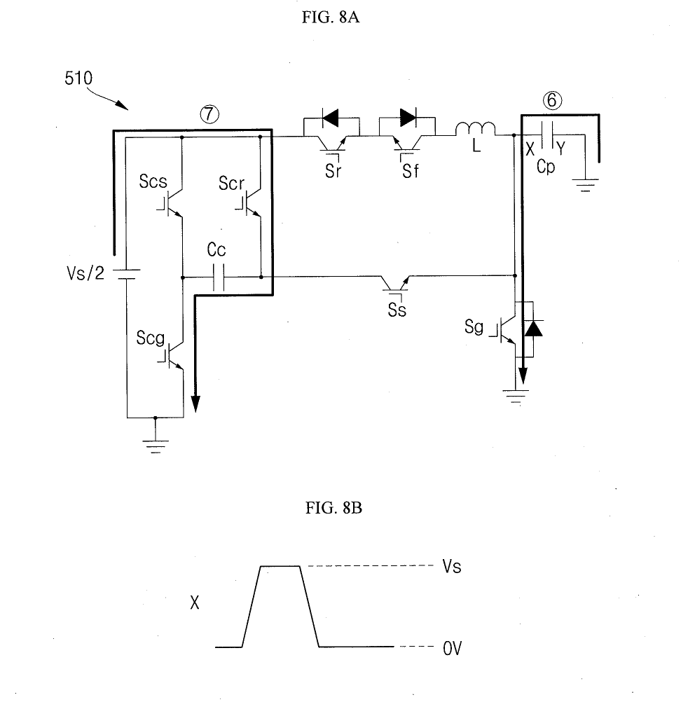

In mode 4 M4, shown in FIG. 8A, the second switch Sf is turned off, and the fourth switch is turned on in a state where the first charge switch Scg and the third charge switch maintain the turn-on state to form a current path from the X electrode of the capacitor Cp to the ground through the fourth switch Sg (\textcircled{6}). Thus, as shown in FIG. 8B, the voltage of the X electrode is maintained with the ground voltage 0V. In addition, a current path is formed from the first terminal of the power voltage source Vs/2 to the second terminal of the power voltage source Vs/2 through the third charge switch Scr, the charge capacitor Cc, and the first charge switch Scg (\textcircled{7}). Thus, the power voltage Vs/2 of the power voltage source Vs/2 may be charged in the charge capacitor Cc.

The mode 1 M1 to mode 4 M4 may be repeatedly performed according to the number of desired sustain pulses.

As described above, in the plasma display device 700 the driving method thereof, the Vs voltage required for the sustain discharge may be applied to the X electrode and/or the Y electrode, which perform the sustain discharge for the sustain period using the sustain pulse generating circuit 510 including the charge circuit 511 and the power voltage source Vs/2 for supplying the Vs/2 voltage.

Therefore, in the plasma display device 700 and the driving method thereof, withstanding voltages of a switching device and various capacitors used for a driving circuit of a plasma display device may be reduced by one half. Also, in the plasma display device 700 and the driving method thereof, since withstanding voltages of the switching device and various capacitors of the driving circuit do not significantly increase even if the Vs voltage increases due to an increase of a content and a pressure of a discharge gas used for the plasma display device, smaller sizes may be used for the switching device and various capacitors.

Thus, in the plasma display device 700 and the driving method thereof, manufacturing costs and power losses may be reduced, and slimness may be realized.

In addition, in the plasma display device 700 and the driving method thereof, since the power source including the existing switching mode power supply supplying the Vs voltage is not required to have the high voltage, design difficulty and an increase of manufacturing costs due to the high voltage design may be avoided.

Although not shown, a plasma display device according to another embodiment may include a plasma display panel (See reference numeral 100 of FIG. 1) including a plurality of X electrodes (See reference numerals X1 through Xn of FIG. 1) and a first sustain driver (See reference numeral 500 of FIG. 1) applying the sustain pulse of FIG. 2 to the plurality of X electrodes X1 through Xn.

The first sustain driver 500 may include a charge circuit, such as charge circuit 511 of FIG. 3, a power voltage source, such as power voltage source Vs/2 of FIG. 3, a first path, a second path, a third path, and a fourth path. Here, the first path may include an inductor L disposed between a first terminal of the power voltage source Vs/2 and the plurality of X electrodes X1 through Xn. A voltage (a Vs/2 voltage that is a half voltage of a Vs voltage) of the power voltage source Vs/2 may be applied to both terminals of the charge circuit 511 through the second path. The third path may connect the first terminal of the power voltage source Vs/2 to the plurality of X electrodes X1 through Xn via the charge circuit 511. The fourth path may connect the plurality of X electrodes X1 through Xn to a second terminal of the power voltage source Vs/2.

As described above, in the plasma display device and the driving method thereof, the Vs voltage required for the sustain discharge may be applied to the X electrode or the Y electrode, which performs the sustain discharge during the sustain period, using the charge circuit of the sustain pulse generating circuit and the power voltage source supplying the Vs/2 voltage.

Therefore, in the plasma display device according to embodiments and the driving method thereof, the withstanding voltages of the switching device and the various capacitors used for the driving circuit of the existing plasma display device may be reduced by one half. Also, in the plasma display device according to the embodiments and the driving method thereof, since the withstanding voltages of the switching device and the various capacitors of the driving circuit do not significantly increase even if the Vs voltage increases due to an increase of the content and the pressure of the discharge gas used for the plasma display device, it may prevent the switching device and capacitors in which a larger withstanding voltage is required from increasing in volume.

Thus, in the plasma display device according to the embodiments and the driving method thereof, the manufacturing costs and power losses may be reduced, and their slimness may be realized.

In addition, in the plasma display device and the driving method thereof, since the power source including the switching mode power supply supplying the Vs voltage is not required to have the high voltage, the design difficulty and the increase of manufacturing costs due to the high voltage design may be prevented.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention.

What is claimed is:

1. A plasma display device, comprising:
a plasma display panel comprising a plurality of first electrodes; and
a first driver connected to the first electrodes, the first driver comprising a sustain pulse generating circuit, wherein the sustain pulse generating circuit comprises:
first and second power receiving terminals configured to receive a power voltage that is about half the voltage of a first voltage applied to the plurality of first electrodes;
a first switch comprising a first terminal connected to the first power receiving terminal;
an inductor comprising a first terminal connected to the first electrodes;
a second switch comprising a first terminal connected to a second terminal of the inductor, and a second terminal connected to a second terminal of the first switch;
a third switch connected to the first electrodes;
a charge circuit connected to the first and second power receiving terminals, the first terminal of the first switch, and a first terminal of the third switch; and
a fourth switch comprising a first terminal connected to a second terminal of the third switch and the first terminal of the inductor, and a second terminal connected to a ground.

2. The plasma display device as claimed in claim 1, wherein the first switch comprises a body diode comprising an anode connected to the second terminal of the first switch and a cathode connected to the first terminal of the first switch.

3. The plasma display device as claimed in claim 1, wherein the second switch comprises a body diode comprising an anode connected to the second terminal of the second switch and a cathode connected to the first terminal of the second switch.

4. The plasma display device as claimed in claim 1, wherein the charge circuit comprises:
a first charge switch connected to the second power receiving terminal;
a charge capacitor comprising a first terminal connected to a first terminal of the first charge switch, and a second terminal connected to the first terminal of the third switch;
a second charge switch comprising a first terminal connected to the first power receiving terminal, and the first terminal of the first switch, and a second terminal connected to the first terminal of the first charge switch and to the first terminal of the charge capacitor; and
a third charge switch comprising a first terminal connected to the first terminal of the second charge switch and the first terminal of the first switch, and a second terminal connected to the second terminal of the charge capacitor and to the first terminal of the third switch.

5. The plasma display device as claimed in claim 4, wherein the second terminal of the first charge switch is connected to the second power receiving terminal.

6. A method of driving a plasma display device, the device comprising a plurality of first electrodes and a power voltage source supplying a power voltage that is about half the voltage of a first voltage applied to the electrodes, the driving method comprising:
increasing a voltage of the first electrodes from the power voltage to the first voltage while charging a charge circuit with a charge voltage;
applying to the first electrodes a voltage that is the sum of the power voltage and the charge voltage;
recovering power from the first electrodes to the power voltage source and to the charge circuit to drop the voltage of the first electrodes from the first voltage to a second voltage lower than the first voltage; and
connecting the first electrodes to a ground.

7. The driving method as claimed in claim 6, wherein increasing the voltage of the first electrodes comprises:
turning on a first switch to create a current path including the first switch, a second switch, and an inductor electrically connected between a first terminal of the power voltage source and the first electrodes to apply the first voltage using a resonance generated by the current path; and
turning on a first charge switch and a third charge switch to create a current path including the first charge switch, a charge capacitor, and the third charge switch disposed between the first switch and the second terminal of the power voltage source to charge the charge capacitor with the power voltage.

8. The driving method as claimed in claim 7, wherein applying to the first electrodes a voltage that is the sum of the power voltage and the charge voltage comprises turning off the first switch, the first charge switch, and the third charge switch, and turning on a second charge switch and a third switch to form a current path from the first terminal of the power voltage source to the first electrodes through the second charge switch, the charge capacitor, and the third switch.

9. The driving method as claimed in claim 8, wherein recovering power from the first electrodes comprises:
turning off the second charge switch and the third switch, and turning on the second switch to drop the voltage of the first electrodes from the first voltage to the second voltage using a resonance generated by a current path formed from the first electrodes to the first terminal of the power voltage source through the inductor, the second switch and a body diode of the first switch; and
turning on the first charge switch and the third charge switch to recover the first voltage of the first electrodes using a current path formed from the first electrodes to the second terminal of the power voltage source through the inductor, the second switch and the body diode of the first switch, the third charge switch, the charge capacitor, and the first charge switch, to charge the charge capacitor with a voltage about half the voltage of the first voltage.

10. The driving method as claimed in claim 9, wherein connecting the first electrodes to a ground comprises:
turning off the second switch, and turning on a fourth switch connected between the first electrodes and the ground to maintain the voltage of the first electrodes with the second voltage using a current path formed from the first electrodes to the ground through the fourth switch; and
charging the charge capacitor with the power voltage of the power voltage source using a current path formed from the first terminal of the power voltage source to the second terminal of the power voltage source through the third charge switch, the charge capacitor, and the first charge switch.

11. A plasma display device comprising:
a plasma display panel comprising a plurality of first electrodes; and
a first driver configured to apply a sustain pulse to the first electrodes, wherein the first driver comprises:
a charge circuit having first and second charge terminals;
first and second power receiving terminals for receiving power from a power voltage source;
a first path comprising an inductor disposed between the first power receiving terminal and the first electrodes;
a second path for applying a voltage of the power voltage source to the first and second terminals of the charge circuit;
a third path for connecting the first power receiving terminal to the first electrodes via the charge circuit; and
a fourth path for connecting the first electrodes to the second power receiving terminal.

12. The device of claim 11, wherein the charge circuit comprises:
a first charge switch connected to the second power receiving terminal;
a charge capacitor connected to the first charge switch;
a second charge switch connected to the charge capacitor and to the first power receiving terminal; and
a third charge switch connected to the charge capacitor and to the first power receiving terminal.

13. The device of claim 11, wherein the first path further comprises first and second switches, the first switch connected to the first power receiving terminal and the second switch connected to the inductor.

14. The device of claim 13, wherein the first path further comprises a body diode of the second switch.

15. The device of claim 11, wherein the second path further comprises first and third charge switches, the first charge switch connected to the second power receiving terminal and the third charge switch connected to the first power receiving terminal.

16. The device of claim 15, wherein the second path further comprises a charge capacitor.

17. The device of claim 11, wherein the third path comprises a second charge switch, a charge capacitor, and a third switch.

18. The device of claim 11, wherein the fourth path comprises first and second switches, a third charge switch, a charge capacitor, and a first charge switch.

19. The device of claim 11, further comprising a fifth path for connecting the first electrodes to a ground.

20. The device of claim 19, wherein the fifth path comprises a fourth switch.
